(19) United States
(12) Patent Application Publication
(10) Pub. No.: US 2014/0278287 A1
(43) Pub. Date: Sep. 18, 2014

(54) Numerical Method to determine a system anomaly using as an example: A Gas Kick detection system.

(71) Applicant: Leonard Alan Bollingham, Baton Rouge, LA (US)

(72) Inventor: Leonard Alan Bollingham, Baton Rouge, LA (US)

(73) Assignee: Leonard Alan Bollingham, Baton Rouge, LA (US)

(21) Appl. No.: 13/803,183

(22) Filed: Mar. 14, 2013

(51) Int. Cl. G06F 17/50

(52) U.S. Cl. CPC G06F 17/5009
USPC 703/2

(57) ABSTRACT

This numerical method creates a mesh of tracers or indicators within a simulator which help determine what various anomalies may look like in real time applications. In this situation, determining gas kicks while drilling for oil and preventing blowouts: This application will provide more stable dependable message passing, reservoir data from the kick, production facility design criteria, and of course better prevent disasters.

This numerical method involves a simulator that accounts for everything normal to a system. Whether it is blood flow, or piping, heat transfer, climatology, or any type of motion: this numerical methods technique will help move simulation to real time monitoring systems. We use as one example: the phenomenon of high pressure gas and/or oil entering a drilling annulus causing a “gas kick” which will lead to a blowout.

Simulations have shown that given different scenarios of depth, reservoir characteristics, and pressure: The time it takes for a high pressure gas kick to reach the surface can be just a few minutes. As witnessed in the BP Gulf of Mexico blow out, loss of life and damage to the environment can be cataclysmic.

The inventor uses known technology for message passing from the drillbit to the surface but in different message densities. Current art sends binary as a pulse for a one, and a blank for a zero. This device will send one fixed interval pulse. There are additional controls for the messages sent. Also certain anomalies at the receiving end are detected with this innovation, and treated as a gas kick.

All of the technologies are available, and the innovative information control system of detection, interpretation, and actions make this innovation very important.

The current art only detects the gas, or noise, or velocity. If the signal reaches the surface pandemonium ensues. There is no indicator of the gas kick height, pressure, or content. There is no indicator of how long it will take to reach the surface or if the BOP can be closed in time. The current art is the best billions of research can buy. That is, until this innovative system is patented for production.

### BACKGROUND

This patent application deals with numerical methods and simulation also applied specifically to BlowOut Prevention and Gas Kick detection while drilling for oil in the Petroleum Industry. With the memory of the BP oil spill in the gulf still in our minds, I hope to offer a very efficient early warning system. This has proven incredibly difficult given the outrageously violent characteristics of drilling an oil and gas well. The amount of time to detect a gas kick before it blows out is just a couple minutes. The inventor has a BS in Petroleum Engineering with an MS in Systems/Computer Science with minor in Petroleum Engineering. The Masters Thesis was this simulation of a gas kick and the resulting blowout. The PhD is an ongoing quest. This work is a result of a lifelong vocation/hobby of simulation and numerical methods. When the BP oil spill wrecked the Louisiana coast, this simulation was put back into action. Past experiments were reproven, and this innovation will save lives, the environment, and lots of money. A field was secured and real testing proved successful.

The current art monitors only the pressure in the well, or level of mud in the mud tank and by the time these are indicators usually are too late. MWD devices are very expensive and suffer from poor message passing efficiency. This innovative application is the answer to every problem cited.

I claim non copyrighted and not even mentioned from the spring of 1986, two systems which combined to contribute to the successful exactness and correctness of the resulting system of this great work. I feel these blowout events can be completely prevented, and the information recorded will help with the production facility design and well completions. I am submitting as a small entity as is with a claim to priority from most of the work in 1986 in PETE 7241 MWD. I have read of 100s of blowouts. Please let's fix this now. It too was so important to this groundbreaking numerical methods research. The mandrel was used to simulate a blowout, and test this system. The blowout detection was one use of the simulation. Only the simulation results concerning various reservoir characteristics were published as a dissertation and in a paper. The mandrel, and gas kick detection research were never mentioned. I have spent everything on these fields and the tests, they are producing a bit. I am forced to keep in mind the changing laws I just found out about. I am selling my house, but at this time decided to try this process prose.

### BRIEF SUMMARY OF THE INVENTION

Given a Master's Thesis Fortran program which is an incredibly accurate blowout simulator, three numerical methods courses on the way to the Computer Science PhD, and the BP oil disaster wrecking my states coastline: I started working on this almost exclusively in my spare time. Tested against actual blowouts and controlled lab experiments this simulator proved incredibly accurate, but nothing to solve this detection problem. So I created my own numerical simulation method technique heretofore known as “The Bollingham Technique”. The problem was to devise a method to detect the gas kick, and stop it in the well before it escaped and caused damage. I started with known proven mud pulse message passing technology as the only tools. Knowing I had only a few minutes to detect and close the BOP as the design constraint.

The “Bollingham Technique” involves placing tracers at specific intervals, and simulating normal conditions plus message travel rates. Then to compare them when the anomaly is added to the system. By detailing what is necessary to recognize, the detection system can be trained to spot similar anomalies outside the norm. This numerical technique has applications in just about every industry and natural phenomenon. There was no precedence to this work, and still isn't. It was never mentioned in any way until this patent application.

This innovation will save lives, and prevent disasters and is of the utmost importance. Using the “Bollingham Technique”: Gas will be detected at the drillbit when information is transmitted to the surface in time to close the Blow Out Preventer (BOP). The communication system will prove effective before current means of detection are even noticing a change. This is very serious and very important as we drill deeper, and experience higher pressures. It is also very applicable to every form of simulated systems and the detection of abnormal anomalies and in helping to design real systems to work faster and with closer tolerances.

The communication system will prove effective before current means of detection are even noticing a change. A blow out simulator programmed as a thesis in grad school which started in a Measurement While Drilling course in 1986 is quite the priority to being very close to this invention. I have not had the money to finish the work but think at this time it is extremely likely that this will be successful very quickly. I finally secured some leases. I am making use of current 1980s technology for communication from the drillbit to the surface. I am adding some detection and message passing algorithms of my own. There are no systems like this in any industry as the violence of drilling wrecks everything. This system works in Rotary and Directional drilling, and is much less expensive, and simpler than sending location, and logging information too. It is a dedicated blowout prevention system, and does not interfere with other technologies.

MWD messages are extremely redundant as the bit moves very slow and positioning and logging information does not change fast. So missing some of the transmissions is not a problem, as they are repeated so many times. However, it is when the information contains notifications of a blowout that it is very important not to have failed message passing. Also, the sensitivity of noise or gas detectors or speed can be erratic. It is not a perfect system but the best until this system becomes available.

Simulations have been yielded wonderful results. Some of the blowout results were unbelievable, as with a 10,000 ft well like BP, and a 500 md reservoir as they estimated the similar reservoir pressure and mud weight showed the blow out covering the depth in less than 4 minutes, and the last 5000 ft in under 30 seconds. This is very serious and very important as we drill deeper, and experience higher pressures. This is the answer which will save so many lives and prevent so many disasters. The mud weight, the height of the gas kick, the length of the normal time sliced slug is compared to the intervals and lengths of the slugs once the gas kick enters the well. This system can is incredibly fast, actually it is unbelievably fast. Whole companies have been lost because of these accidents. Whole reservoirs have been ruined, and so has the environment. This system is extremely simple, and robust. The sending unit does not detect anything it just sends a pulse, and it can be placed a safe distance from the drillbit where noise and vibrations have settled down. This makes for very high quality dependable message passing.

This numerical methods system defines exactly what needs to be added to the system, monitored, and how it is to be interpreted to provide safe handling of this type of disaster. By using the entire mud column as the indicator this system is revolutionary across all industries, and especially the billion dollar problem of gas kicks leading to blowouts.

This system is much simpler as one single pulse is created each interval of a second or two. There isn't any binary concerns by the sending unit, so the cost of the sending unit is greatly reduced. It works in stationary directional drilling, and also is the only system that works in rotary drilling applications. The sender does not have to be at the drillbit but perhaps a couple hundred feet up the drill string away from all the noise and vibration. This provides a smoother medium to pass messages.

The receiver could also be redundant and located within a choke which can slow down the gas kick by restricting mud flow and increasing pressure. These are available but not used in this way simply because current art has no clue where the top of the gas kick is located. This system does, as the reduction of the signal interval, time and pressure indicate how high the gas kick as travelled into the annular borehole space. This is monumental improvement to the art. Gas kicks can be handled and the information now being lost with current art, can be collected and used to help complete the reservoir and also design the production facilities.

### BRIEF DESCRIPTION OF THE DRAWINGS

FIG. 1 shows the drilled hole which has not reached the high pressure gas zone. Everything is normal to the control unit (10), mud is normal speed and quantity, signals are perfectly distanced (30), the BOP is open (80).

FIG. 2 illustrates the drilling has reached the gas zone, mud is speeding up, signals in the well already are compressed (40), signals going into the well are more spaced out (50) as mud is moving faster. BOP is closed (90), siren is going off as the control unit is in a state of emergency (70). Actually the pulses start to level out again but the pulses during the gas kick entrance can still be recorded.

### IDENTIFICATION OF PARTS/COMPONENTS OF INVENTION

10 Control unit in idle state (FIG. 1)
20 Sending Unit
30 Signals in normal intervals (FIG. 1)
40 Signals before gas kick are compressed (FIG. 20)
50 Signals after gas kick are separated farther apart (FIG. 2)
70 Control unit in alert state (FIG. 2)
80 BOP normal state, open (FIG. 1)
90 BOP kick state, closed (FIG. 2)
100 Mud Tank
200 Well at the surface
300 Well at the drilled depth
400 High Pressure Gas Zone

### DETAILED DESCRIPTION AND BEST IMPLEMENTATION

The “Bollingham Technique” is used in this Blow Out detection system by placing sending unit on the collar or as part of the drillbit (20). A receiving unit is placed at the surface (10). The system begins normal operation with an open BOP (80). The sending unit acts as a notification of a gas kick (70) as the column is full of even spaced messages which get compressed due to the increase in the speed of the mud flow. The control unit is also simulating the progress of the gas kick given the information gathered. This allows for time to close the preventer: The BOP is closed in plenty of time to stop a disaster (90). In fact, the sooner the better as heavier mud can be circulated into the well to offset the kick pressure. This method can work minutes faster than any other system.

The sending and receiving technology were first used in the 70s for directional drilling. To design a system to detect gas kicks using the “Bollingham Technique” is new as is the special sending unit (20), and the logic unit is new (10, 70). Making use of a stable constant pulse messaging technology to detect a Doppler like affects or a compression of the interval between received messages which can only be caused by extreme pressure of gas and oil entering the annulus from a newly discovered producing zone/reservoir. The gas kick causes extra volume to enter the well, and this cause an acceleration of the mud column out of the borehole. This acceleration causes a reduction in the interval of the messages at the top of the well detected by the receiver. This information can be used to quickly stop drilling to minimize the amount of gas that enters which is critical. Drilling can possibly stop in just seconds. With the simulation and such exact measurement of where the top of the gas kick is located, the reservoir information given during the blowout can indicate all sorts of great things about the reservoir. Pressure, permeability, etc all can be closely estimated from the message passing information that is recorded. Current art cannot tell where the top of the gas kick is, and this causes the BOP to be closed in cases where circulating heavier mud can alleviate the problem. A controllable choke can be used, with the safe time necessary to close the BOP always allowed before the gas kick reaches the surface.

Shallow blowouts are the most dangerous as there is virtually no time from the kick to the blow out. The simulator can use drill depth to determine the safe depth at which a gas kick can be detected and the BOP can be closed without issues. This is a very simple and effective system.

A detection system has been simulated that is placed on the drill string up a sufficient distance from the sending unit. This completes a real GasKick/BlowOut detection system built according to the “Bollingham Technique”, which involves a proprietary sending unit at the drill bit, a receiving/logic unit at the surface which displays gas kick activity in the annulus, and can alert the crew to close the BOP. The receiving unit detects changes in the patterns of the information received due to extra velocity in the annulus which causes Doppler or Doppler-like affects in the annular mud which indicates a gas kick has entered the annulus. Different types of pulses are used so that one type may work better than the others but at least the kick will be discovered as quickly as possible. Several types of messages, sounds, pulses, and configurations can be used to find the quickest way to detect that a gas kick has entered the annular drill space. A sending unit that can transmit fluid pulses, sound, or combinations of signals in any format or interval. A receiving/control unit that can interpret mud speed, signal speed and intervals, and make logical decisions to alert the crew or just monitor. This type of system can be added to any simulation in any study which deals with detection of some known type of motion or anomaly which can be simulated. A speaker system can be playing the signal received, and everyone on the drilling floor can hear the ever increasing pace of the signal as the gas kick races to the surface. The progress of the kick can be simulated from this signal information and other known factors of the drilling progress and systems. The progress can also alert the crew to prepare for trouble, watch the mud tank for greater than normal gains which is a great indicator of extras in the annular space.

In FIG. 1 the “Bollingham Technique” is in the start or normal mode where drilling is normal the signals are evenly spaced, and the mud is flowing at a constant rate (30). In FIG. 2 the “Bollingham Technique” is in the alert mode where a high pressure zone is drilled into, the signals in the annular space start being compressed (40), and the signals sent after the kick enters the well are stretched out more and more as the mud and gas start to move very fast (50).

There can be many scenarios of message design, as many were tried by adding sound waves and fluid pulse riders to the drilling mud as it left the drill bit. These were tracked to show patterns under all sorts of conditions and proved to be very indicative of trouble. The “Bollingham Technique” involves any type of signal/reception. What is important is detecting the dangerous new presence as quickly as possible and safely handling the problem.

One simulation shows the one second time slices to be 1 foot long under normal conditions of a constant drilling mud flow and no extra oil or gas coming into the borehole. At 30 seconds after the gas kick has started the 1 second time slices are over 2 feet long. Time intervals at the surface are now 0.95 seconds. If the message passing can be trusted then 0.05 seconds difference is worth taking the chance of stopping drilling to check for a gas kick. At 100 seconds after the gas kick has begun the 1 second time slices are over 10 feet in length. The density of the mud is dropping and the gas is expanding while more oil and gas are blasting into the borehole annular space. All of this information tells exactly what the reservoir is capable of producing. The top of the gas kick is racing toward the surface, and the surface time slices are about 0.90 seconds. Drilling has hopefully been stopped.

The current art still would have no clue anything is going on. Only the level of gas or noise at the drillbit is detected, and hopefully the message is not lost or damaged in transition. The current art trusts that the message will outpace the gas kick. There is no way to know where the gas kick has reached in the borehole. There is no collection of production information from the reservoir during the gas kick. Still this is the best the industry has in an incredibly difficult system of problems.

At this time the BOP should be closing or closed and precautions to circulate and handle the kick should be taken. Alarms can be going off, and all hands are working to control this horrific emergency before it gets out of control. If not, at 200 seconds the 1 second intervals at the drill bit are over 25 ft long. There is no detection of gas or oil, but just a decrease in the interval times of the mud pulses at the surface. The BOP is closed without question, and the disaster is prevented.

I do not have actual BOP details to simulate how it looks but this is something I hope to add in the future as detailed limitations and operating specifics can be added to the simulation which is monitoring and helping to control these disasters in real time. Understand that my simulation has no controls it just shows with no detection how fast the blowouts occur. When the gas and oil come out the well the fluid is moving at over 100 mph. Sand hits any metal and a spark occurs. Total disaster ensues. I know we can stop these with this numerical method simulation driven real time system and known/proven industry hardware. Companies, lives, nature, property, and the reservoir are damaged or lost.

When 6′ of oil and gas enter the borehole in one second at the bottom, SIX one second intervals pass through the detection point at the top. Instead of 1 second intervals they are ⅙th of a second intervals. It isn't exact because oil mud compresses somewhat. However, it is enough to know there is a problem. So the instant it happens, the expected signal at the top is indicating successfully. Safety and other concerns can be started as the minimum time required to close the BOP can be assured. This floored me as the investigator, I have tried so many things over the years. This is phenomenal! Thank you sincerely.

I claim:

1. A numerical method system which adds constant interval signals to the simulation to establish normal conditions as collected by a receiver, and then add an intrusion to study the changes which will lead to parameters for the detection of the intrusion by these constant signals.

2. The system according to claim 1, where the simulation of a real world environment is enhanced by additional signals which create a mesh of indicators or alarms.

3. The system according to claim 1, where the simulation of a real world environment is enhanced by a detection point or points which collect the mesh signals to determine if the environment is normal or has been changed in any way. The mesh interval and shape is the information.

4. The system according to claim 1, where the simulation of the real world environment can help define what types of changes occur given a known simulated intrusion so that real intrusions in the real system can be detected more quickly and efficiently.

5. The system according to claim 1, where the sending unit is sending evenly intervaled signals, and when these controlled intervals expected by the receiver are different intervals then something has entered the detection space.

6. A real GasKick/BlowOut detection system built according to the numerical method in claim 1, which involves a proprietary sending unit at the drill bit, a receiving/logic unit at the surface which displays gas kick activity in the annulus, and can alert the crew to close the BOP.

7. The system according to claim 6, where the receiving unit detects changes in the mesh intervals of the information received due to extra velocity in the annulus which indicates a gas kick has entered the annulus.

8. The system according to claim 6, where the different types of pulses are used so that one type may work better than the others but at least the kick will be discovered as quickly as possible.

9. The system according to claim 6, where the top of the gas kick can be determined by counting the extra intervals that have left the annular space ahead of schedule.

10. The system according to claim 6, comprising a sending unit that can transmit fluid, sound, or combinations of signals at a preset constant interval.

11. The system according to claim 6, comprising of a receiving/control unit that can interpret mud speed, signal speed and intervals, record this information for evaluation, and make logical decisions to alert the crew or just monitor.

12. The system according to claim 6, comprising of a receiving/control unit that can record information which later can be used to determine flow characteristics of the reservoir which will help with completion design and production facility design.

13. The system according to claim 6, comprising of a receiving/control unit that can interpret information received about the pressure of the column of mud and height of the gas kick so that once the BOP is closed: Heavier mud can be sent into the annular space to reverse the gas kick and continue drilling safely.

14. The system according to claim 6, comprising of a receiving/control unit that can almost instantly alert the drilling crew to stop drilling, this safety measure and be decided by the driller when in just seconds it is definitely proven that a gas kick has entered the well. Stopping the drilling will prevent an increase in the amount of the reservoir that is loosing oil and gas into the well.

15. The system according to claim 6, comprising of a receiving/control unit that can estimate how long it will take for the blowout to occur and make sure the BOP will have the 30-45 seconds to close.

16. The system according to claim 6, where after the gas kick has been contained, the system can record all the tracer and interval information and continue doing this until the signals resume their normal interval minus the distance of mud not flowing.

17. The message system in claim 2, which can be added to any simulation in any study which deals with detection of some known type of intrusion or use of information in any way which can be simulated such as climatology, heat transfer, electrical circuits, gravitational wave systems, etc., to help monitor and record information metrics.

18. The numerical method in claim 1, which can be added to any realtime actual system and then used to control events.
